(19) United States
(12) Patent Application Publication
(10) Pub. No.: US 2003/0088372 A1
(43) Pub. Date: May 8, 2003

(54) Array calibration and quality assurance

(76) Inventor: David D. Caulfield, Spruce Grove (CA)

Correspondence Address: JOHN BAKER, KIRBY EADES GALE BAKER, P.O. BOX 3432, STN.D, OTTAWA, ON, K1P 6N9, CA

(21) Appl. No.: 09/985,231

(22) Filed: Nov. 2, 2001

(51) Int. Cl. G06F 19/00

(52) U.S. Cl. 702/40

(57) ABSTRACT

Acoustic and electro-magnetic (pulse or modulated radar and X-ray) data acquisition frequently requires the use of detectors arranged in an array. In this way, the data acquired by each detector in the array can be integrated to improve the quality and accuracy of data retrieved. The present invention provides a system and method for the calibration of detectors for quality assurance. Preferably, the system and method are suitable for field application immediately prior to and post data acquisition.

### FIELD OF THE INVENTION

The present invention relates to the fields of acoustic and electro-magnetic (radar, X-ray) data acquisition. Acoustic and electromagnetic (EM) data, and in particular seismic data, is frequently collected via an array of acoustic or EM detectors. In this regard, the present invention relates to calibration of acoustic or EM detectors for improving the accuracy of acoustic or EM data acquisition and analysis.

### BACKGROUND TO THE INVENTION

Acoustic and EM data can be collected and analyzed for many applications, including both geological and marine measurements. For this purpose, systems have been developed to permit data acquisition of acoustic and EM data for analysis of material properties of subterraneal rocks and sediments, as well as material layers beneath marine floors and river beds. Typically, the information gathered may include material density, layer thickness, and material classification, as well as information regarding the nature of the interfaces between the material layers.

To gather relevant information, acoustic and EM data systems generally include a source of acoustic or EM energy to generate an acoustic or EM signal. The source is orientated to direct the signal towards one or more material layers/interfaces of interest. The signal is reflected in part by each material interface, thereby resulting in more than one reflected signal from one original signal incident to the material layers. Information regarding the reflected signals is typically collected using one or more acoustic or EM detectors.

To maximize their potential data acquisition, the detectors can be arranged in a specific array, wherein the detectors in the array are located in a desired position relative to one another. In this way, the reflected signals received by each detector in the array can be integrated to provide a more detailed ‘picture’ of the material layers under analysis. In this case, ‘picture’ refers to graphical display of the information and/or detailed analytical information of the material layers.

It is known in the art that arrays of suitable detectors may be utilized for many acoustic and EM analytical operations to improve the accuracy and reliability of reflected signal data. Moreover, it has been found that such acoustic arrays are particularly useful for marine geophysical analysis, where detailed information is required of marine floor sediments and layers.

For example, acoustic detectors can be arranged in series, wherein each detector is located in a line at a known distance from the acoustic source. Such an arrangement is particularly useful for marine geophysical data analysis, since the array of detectors can be readily towed behind a ship. In one typical arrangement, the acoustic detectors (also known as hydrophones for marine analysis) may be attached to a cabling system. The cabling and attached hydrophones may be wound onto a collection drum and deployed into the water prior to data acquisition.

Acoustic detectors suitable for acoustic/seismic data acquisition, and EM detectors suitable for EM data acquisition, are sensitive instruments required to operate with a significant degree of accuracy. For this purpose, the detectors (and their related systems) are carefully tested at the point of manufacture to ensure accuracy within specified requirements. The inventor of the present application has determined that the accuracy of such detectors is particularly important when the detectors are arranged in an array, and the information gathered from the detectors is integrated. If one detector is not functioning properly and producing poor quality results, then the accuracy of the entire array may be affected. This in turn results in a considerable drop in data acquisition efficiency. Furthermore, the inaccuracy of the data may not be realized if the poor detector performance remains unnoticed.

Therefore, there is a need for method and system for testing the sensitivity of acoustic or EM detectors after they have been manufactured. More particularly, there is a need for testing and calibrating the sensitivities of acoustic and EM detectors arranged in an array of detectors.

### SUMMARY OF THE INVENTION

The present invention provides a system and method for calibration of acoustic or EM detectors deployed for the collection and analysis of acoustic or EM data. Importantly, the system and method of the present invention are preferably suitable for acoustic or EM detector calibration in the field, at the site of data acquisition. In this way, the receive sensitivity of each detector can be determined in situ, immediately before the investigations commence. On the basis of the calibration information, adjustments can be made to the data received by each acoustic or EM detector during subsequent acoustic or EM data acquisition, thereby permitting correction of unwanted anomalies in the sensitivity of each detector.

In one aspect, the present invention provides a system for calibrating acoustic or EM detectors or determining the sensitivity of acoustic or EM detectors. Preferably, the system permits the acoustic or EM detectors to be calibrated from a remote location.

In another aspect, the present invention provides a system for calibrating acoustic or EM detectors in an array of acoustic or EM detectors designed for data acquisition.

In another aspect, the present invention provides a system for checking acoustic or EM detectors in an array of detectors for damage or malfunction. In this way, the data received by damaged or malfunctioning detectors can be corrected by suitable data processing, or alternatively can be disregarded in the overall analysis of the data received by the array.

In another aspect, the present invention provides a method for detecting the receive sensitivity of an acoustic or EM detector. Preferably, the receive sensitivity may be compared to an expected receive sensitivity value. In this way, the difference between the actual and the expected receive sensitivity of the acoustic or EM detector can be corrected.

In yet another aspect, the present invention provides a method for calibrating acoustic or EM detectors arranged in an array of acoustic or EM detectors designed for acoustic or EM data acquisition. Preferably, the method is suitable for calibration in the field at the site of acoustic or EM data acquisition. In this way, detector sensitivities can be checked immediately prior to the commencement of data acquisition and analysis, thereby permitting accurate correction of the data received.

In a first embodiment, there is provided a system for calibrating at least one data acquisition acoustic or EM detector arranged in an array, the system comprising:

a calibration acoustic or EM source, capable of generating an acoustic or EM signal of known level;

a calibration acoustic or EM detector of known sensitivity;

a data acquisition acoustic or EM source;

wherein said calibration acoustic or EM source directs a first acoustic or EM signal to a reflective interface, said first acoustic or EM signal being reflected by said reflective interface and detected by said calibration acoustic or EM detector, thereby permitting calculation of a bottom loss value at the reflective interface;

said data acquisition acoustic or EM source directs a second acoustic or EM signal to said reflective interface, said second acoustic or EM signal being reflected by said reflective interface and detected by said calibration acoustic or EM detector, thereby permitting calculation of a level of said second acoustic or EM signal upon initial transmission;

said at least one data acquisition acoustic or EM detector detecting further acoustic or EM signals generated by said data acquisition acoustic or EM source and reflected by said reflective interface, thereby permitting calculation of a sensitivity of said at least one data acquisition acoustic or EM detector.

In a second embodiment, there is provided a system for calibrating at least one data acquisition acoustic or EM detector arranged in an array, the system comprising:

a calibration acoustic or EM detector of known sensitivity;

a data acquisition acoustic or EM source;

wherein said data acquisition acoustic or EM source directs a first acoustic or EM signal to said calibration acoustic or EM detector, thereby permitting calculation of an initial level of said first acoustic or EM signal upon propagation from said data acquisition acoustic or EM source;

said data acquisition acoustic or EM source directs a second acoustic or EM signal to a reflective interface, said second acoustic or EM signal being reflected by said reflective interface and detected by said calibration acoustic or EM detector, thereby permitting calculation of a bottom loss value at said reflective interface;

said at least one data acquisition acoustic or EM detector detecting further acoustic or EM signals generated by said data acquisition acoustic or EM source and reflected by said reflective interface, thereby permitting calculation of a sensitivity for said at least one data acquisition acoustic or EM detector.

In a third embodiment, there is provided a system for calibrating each acoustic or EM detector in an array comprising at least two acoustic or EM detectors, the system comprising:

a data acquisition acoustic or EM source;

wherein said data acquisition acoustic or EM source directs a first acoustic or EM signal of an initial level to a first reflective interface, said first acoustic or EM signal being reflected by said first reflective interface and detected by a particular data acquisition acoustic or EM detector within said array;

said data acquisition acoustic or EM source directs a second acoustic or EM signal to said first reflective interface, said second acoustic or EM signal reflected by said first reflective interface to a second reflective interface and reflected by said second reflective interface back to said first reflective interface, said first reflective interface reflecting said second acoustic or EM signal to said particular data acquisition acoustic or EM detector;

said difference in level of said first and second signals when received by said particular data acquisition acoustic or EM detector thereby permitting:

(a) calculation of a bottom loss value;

(b) estimation of the initial level for the first and second acoustic or EM signals; and

(c) calculation of a sensitivity of each of said at least one data acquisition acoustic or EM detectors.

In a fourth embodiment of the present invention there is provided a method for determining a sensitivity of at least one acoustic or EM detector, wherein the at least one acoustic or EM detector is located to receive an acoustic or EM signal reflected by a reflective interface, the method comprising the steps of:

(a) determining a bottom loss value of acoustic or EM energy not reflected by the reflective interface;

(b) determining a level of said acoustic or EM signal upon initial transmission;

(c) using the bottom loss value and the level of the acoustic or EM signal upon initial transmission, and a level of an acoustic or EM signal received by said at least one acoustic or EM detector, to determine the sensitivity of said at least one acoustic or EM detector.

In a fifth embodiment of the present invention there is provided a method of calibrating at least one acoustic or EM detector, comprising the steps of:

(a) directing a first incident acoustic or EM signal of known initial level from a calibration acoustic or EM source to a reflective interface;

(b) detecting a first reflected acoustic or EM signal derived from said first incident acoustic or EM signal being reflected by said reflective interface, and detected by a calibration acoustic or EM detector of known sensitivity;

(c) calculating a bottom loss value for said reflective interface;

(d) directing a second incident acoustic or EM signal of unknown level from a data acquisition acoustic or EM source to said reflective interface;

(e) detecting a second reflected acoustic or EM signal derived from said second incident acoustic or EM signal being reflected by said reflective interface, and detected by said calibration acoustic or EM detector of known sensitivity;

(f) calculating an initial level for said second incident acoustic or EM signal;

(g) directing at least one subsequent incident acoustic or EM signal from said data acquisition acoustic or EM source to said reflective interface, said at least one subsequent incident acoustic or EM signals being reflected by said reflective interface and detected by said at least one data acquisition acoustic or EM detector; and

(h) using said bottom loss value, said initial level for said second incident acoustic or EM signal, and a level of an acoustic or EM signal received by said at least one acoustic or EM detector to calculate a sensitivity for said at least one acoustic or EM detector.

In a sixth embodiment of the present invention there is provided a method of calibrating at least one acoustic or EM detector in an array of acoustic or EM detectors, comprising the steps of:

(a) directing a first incident acoustic or EM signal of unknown level from a data acquisition acoustic or EM source to a calibration acoustic or EM detector of known sensitivity;

(b) detecting said first incident acoustic or EM signal with said calibration acoustic or EM detector;

(c) calculating an initial level of said first incident acoustic or EM signal;

(d) directing a second incident acoustic or EM signal from said data acquisition source to a reflective interface;

(e) detecting a reflected acoustic or EM signal derived from said second incident acoustic or EM signal, with said calibration acoustic or EM detector of known sensitivity;

(f) calculating a bottom loss value for said reflective interface;

(g) using said bottom loss value and said initial level for said first incident acoustic or EM signal to calculate a sensitivity for said at least one acoustic or EM detector.

In a seventh embodiment of the present invention there is provided a method of calibrating at least two acoustic or EM detectors arranged in an array, comprising the steps of:

(a) directing an incident acoustic or EM signal of unknown level from an acoustic or EM source to a reflective interface;

(b) detecting a first reflected acoustic or EM signal derived from said incident acoustic or EM signal being reflected once from said reflective interface, said first reflected acoustic or EM signal detected by an acoustic or EM detector in said array;

(c) detecting a second reflected acoustic or EM signal derived from said incident acoustic or EM signal being reflected twice from said reflective interface, said second reflected acoustic or EM signal detected by said first acoustic or EM detector in said array;

(d) calculating a difference in level between said first and second reflected acoustic or EM signals;

(e) calculating a bottom loss value for said incident acoustic or EM signal at said reflective interface;

(f) estimating a mean sensitivity for said at least two acoustic or EM detectors in said array;

(g) calculating an estimated initial level of said incident acoustic or EM signal;

(h) calculating an estimated sensitivity for each of said at least two acoustic or EM detectors in said array.

### DEFINITIONS

‘Absorption loss’—the acoustic or EM energy lost by an acoustic or EM signal traversing a medium due to mechanical work or resistivity losses. Normally, for water and air these losses are very small at the low frequencies used in the applications discussed. In special cases where higher frequency are used this absorption term must be added.

‘Array’—at least one acoustic or EM detector arranged in a defined order in one and/or multiple elements located relative to one another. The data collected from one or more acoustic or EM detectors in the array may be integrated to provide an overall ‘picture’ of an area under analysis.

‘Bottom loss’—the term bottom loss is a value proportional to the logarithm of the reflection coefficient (RC) (20*Log(RC)). The reflection coefficient is the ratio of the level of the acoustic or EM signal reflected by a reflective interface divided by the incident acoustic or EM signal, wherein the reflective interface is generally the first interface to reflect a significant portion of the acoustic or EM energy.

‘Transmission loss’—the acoustic or EM energy lost by an acoustic or EM signal as it is transmitted through a medium, resulting from the geometrical spreading of the signal wave front as it propagates through medium. In the examples illustrated herein, the medium is water.

‘Multiple’—this term relates more particularly to marine analysis, but may also relate to other applications. Following propagation of an acoustic or EM signal, the signal may be reflected by a reflective interface back towards a detector. However, a portion of the acoustic or EM signal will undergo more than one reflection. In this regard, the signal may be reflected by the first reflective interface, and subsequently undergo further reflections by a second reflective interface and the first reflective interface. For the purposes of the present application, such multiply reflected signals are known as multiples. For example, the signal illustrated in FIG. 2c represents the ‘first multiple’ for the signal originating from the calibration acoustic or EM source.

### DESCRIPTION OF THE DRAWINGS

FIG. 1 is a representation of a typical acoustic data acquisition system used for marine applications (prior art).

FIG. 2a is an overview of a first embodiment of the calibration system of the present invention.

FIG. 2b is a detailed illustration of the first embodiment of the calibration system of the present invention.

FIG. 2c illustrates an alternative means for calculating bottom loss using the first embodiment of the calibration system of the present invention.

FIG. 3a is an overview of a second embodiment of the calibration system of the present invention.

FIG. 3b is a detailed illustration of the second embodiment of the calibration system of the present invention.

FIG. 4a is an overview of a third embodiment of the calibration system of the present invention.

FIG. 4b is a detailed illustration of the third embodiment of the calibration system of the present invention.

### DETAILED DESCRIPTION OF THE PREFERRED EMBODIMENTS

The present invention encompasses a system and method for testing the receive sensitivity of an acoustic or EM detector, or multiple detectors arranged in an array. Once the receive sensitivity is known for each detector, the receive sensitivities can be compared with expected sensitivities, and each detector can be calibrated accordingly (or disregarded). The system and method of the present invention also permits analysis of the stability of an source. In this way, regular checks can be made to ensure that the output of the data acquisition source does not fluctuate.

The present invention will be described in relation to specific embodiments for acoustic data acquisition systems operating over marine floor bottoms and river beds. However, it will be understood that the systems and methods described herein are applicable to the calibration of any system employing an array of detectors or hydrophones for the purposes of collecting and analyzing signals reflected from material layers. Such examples for acoustic data acquisition may include, but are not limited to, seismic information for earthquake prediction, analysis of fault lines and geological structure, analysis of material layers for explosive fragmentation, detection of natural features below the ground or below water, detection of explosive materials such as mines concealed beneath the earth or sea, detection of deposits of natural gas or oil, evaluation of geological structures for engineering projects. Such examples for pulsed or modulated radar may include, but are not limited to, earth structure studies, water table examination, and buried object detection. Likewise such examples for pulsed or modulated X-rays include baggage inspection, vehicle or truck inspection, medical diagnostics, and detection of buried objects in the ground.

It will be understood that the systems and methods described herein may be applied to any application wherein signals are transmitted and subsequently received by an array of detectors. In this regard, both acoustic or EM signals may be utilized, and subsequently detected using appropriate detectors. For the purposes of illustrating the present invention, the embodiments will be described with particular reference to acoustic data acquisition in an marine setting. However, the present invention is not intended to be limited in this respect, and encompasses a system and method of calibrating both acoustic and electromagnetic detectors for both water based and land based applications, as required.

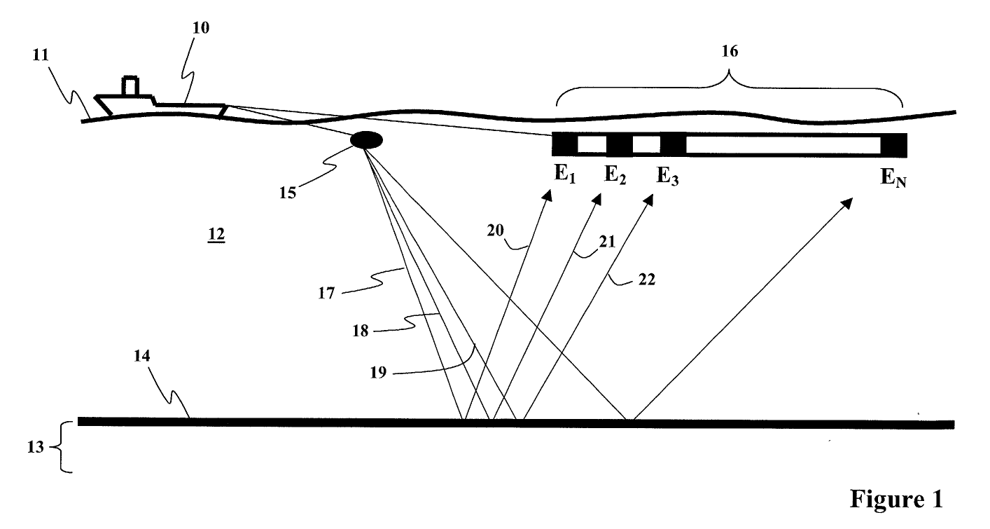

Traditional marine geophysical data acquisition techniques utilize a simple system comprising an acoustic source and an array of acoustic detectors. Typically, the acoustic source and acoustic detectors are towed behind a ship in an arrangement illustrated in FIG. 1. The ship 10 is shown on the surface 11 of the sea 12 above the material of the marine floor 13. There exists a first significant interface between materials of differing acoustical properties 14 (hereinafter termed ‘the interface’) between the sea 12 and the marine floor 13. The interface 14 may be poorly defined, but for the purposes of this explanation the interface exhibits well defined reflective properties that are not susceptible to major acoustic signal scattering or diffraction for normal incident waves used in the calibration process.

An acoustic source 15 is located behind the ship 10. Behind the data acquisition acoustic source 15, an array 16 comprising at least one acoustic detector is also located the ship 10. The detector(s) are arranged in series relative to the data acquisition acoustic source 15, and in FIG. 1 are designated E₁, E₂, E₃ and so on to the final acoustic detector (designated E_{N}). FIG. 1 further indicates a series of acoustic signals 17-19 originating from the data acquisition acoustic source 15 and directed towards the interface 14. The acoustic signals 17-19 become reflected at interface 14 to produce the corresponding reflected acoustic signals 20-22. These reflected acoustic signals may be detected by the array of acoustic detectors.

In practice, the original signals 17-19 are not reflected completely at interface 14 for three principle reasons. Firstly, a portion of the acoustic energy will be refracted at the interface and therefore not reflected back to the surface. Secondly, another portion of the acoustic signal will be scattered at the interface, particularly if the interface is poorly defined. Thirdly, another portion of the signal will be transmitted across the interface and into the material of the layer. Therefore, some acoustic energy may be considered ‘lost’ at the interface, and not directed back to the array of detectors. When near normal incidence signals are used, a significant proportion is predicted to be lost via transmission of the acoustic energy. In any event, the signal level reflected by the first principle interface divided by the incident level is referred to as the bottom reflection coefficient, which in turn permits the calculation of ‘bottom loss’. As may be expected, the bottom loss for a particular data acquisition area may change, particularly if the acoustic detection array is attached to a moving ship. The bottom loss for a particular interface is a measure of the energy not reflected by the interface.

Analysis of the portion of the acoustic energy transmitted to the next material layer, and subsequent reflection of this transmitted signal from deeper interfaces, can provide important information regarding the structure and properties of a material layer. Although such factors will not be given further consideration in this instance, it will be understood that complex analysis of all reflected signals can provide a detailed ‘picture’ of material layers, their components and thicknesses. However, for the purposes of illustrating the present invention, consideration will only be made of those signals reflected at the first principle interface, for example the marine floor or river bed for an acoustic system.

Another portion of the acoustic signals 17-19, and their corresponding signals 20-22, is lost due both to ‘transmission loss’ and ‘absorption loss’ through the media. Transmission loss occurs due to geometric spreading of the signals through the media, and the transmission loss is a function of ray path length. At higher frequencies, some of the energy of signals 17-19 and their corresponding signals 20-22 will also be absorbed during transmission through the water (absorption loss). In most practical applications this absorption loss can be neglected, and for the sake of simplicity will not be given further consideration in this instance. However, if required this additional term can compensated for. In any event, the transmission loss and absorption loss will be a negative value resulting in a reduction of the level of the acoustic signal. In simplistic terms, the level of the acoustic signal transmitted by the data acquisition acoustic source and the level of the acoustic signal received by the acoustic detectors will be different, and this difference will result primarily from bottom loss and transmission loss considerations (absorption loss at lower frequencies can generally can be neglected).

Systems for acquiring acoustical data are susceptible to inaccuracies caused by malfunctioning acoustic detectors. However, once the acoustic detectors are distributed by the manufacturer, recalibration is rarely instigated. In particular, practical issues can prevent direct recalibration of acoustic detectors from taking place. For example, if the acoustic detectors are linked by cables, they may be wound onto a drum on the back of a ship for storage. Therefore, the detectors are not readily accessible for calibration.

The present invention provides a system and a method for testing the sensitivity and for calibrating acoustic detectors. In particular, the system of the present invention is preferably configured to permit calibration of acoustic detectors in their place of deployment. In this way, data acquired from poorly functioning acoustic detectors may be electronically corrected, or disregarded, without removing the acoustic detectors from their optimal position for data aquisition.

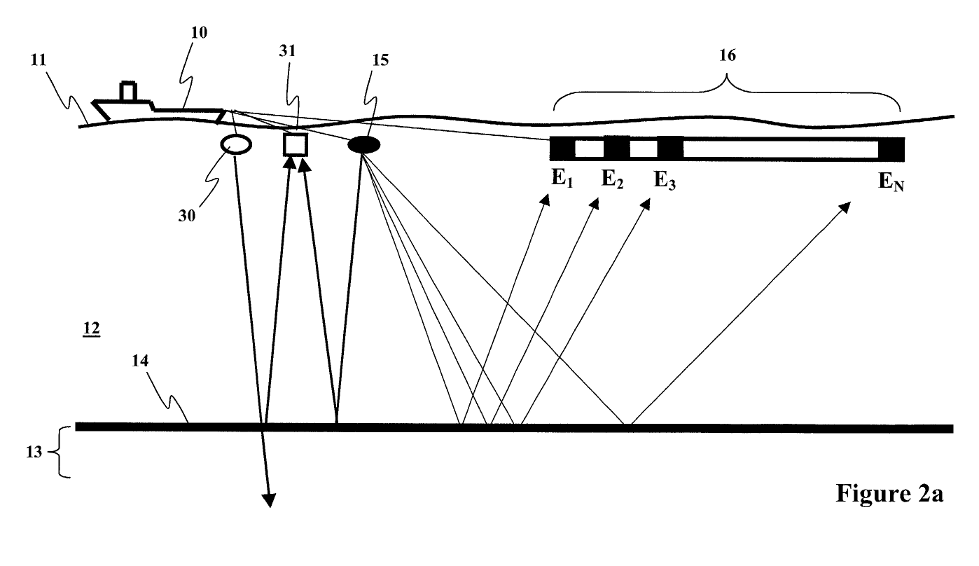

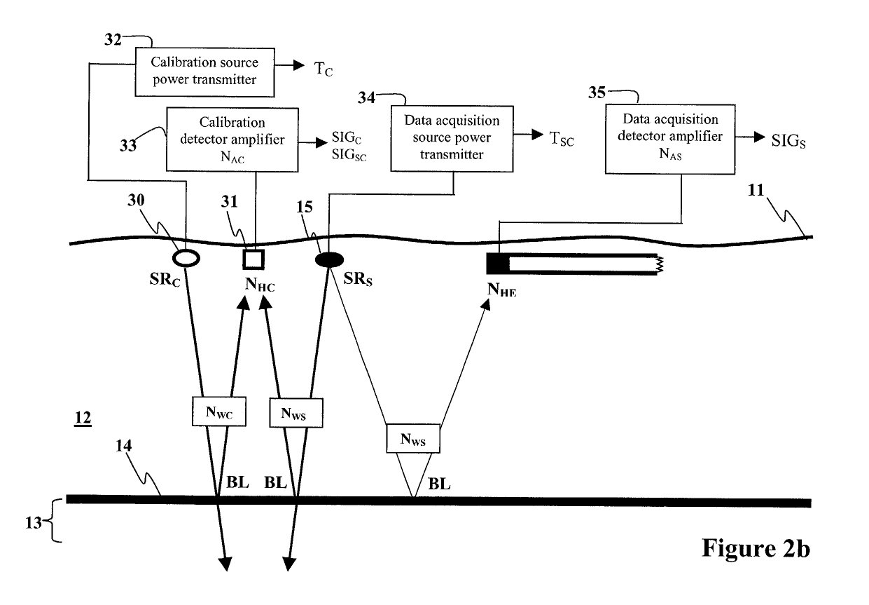

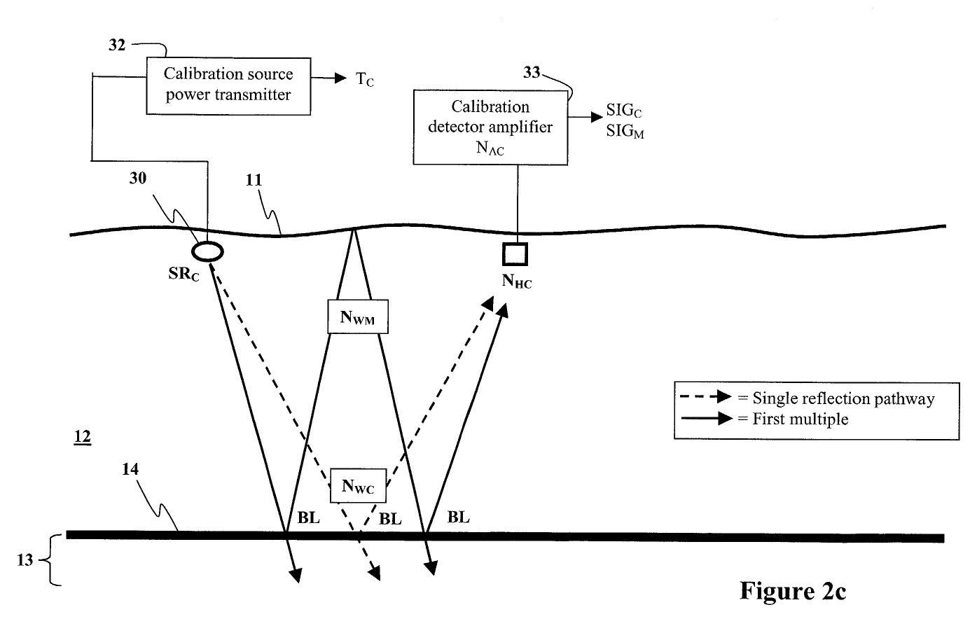

A first embodiment of the invention is illustrated with reference to FIG. 2a. In this regard, FIG. 2a illustrates a preferred system of the present invention. The overall arrangements of the ship, the data acquisition acoustic source, and the array of acoustic detectors (E₁ to E_{N}) are the same as illustrated in FIG. 1. However, the system shown in FIG. 2a differs from FIG. 1 in that it comprises two further components: a calibration acoustic source 30 and a calibration acoustic detector 31. The calibration acoustic source 30 and calibration acoustic detector 31 are illustrated in FIG. 2a positioned roughly horizontally in line with the data acquisition acoustic source 15 and the array of data acquisition acoustic detectors 16. However, the calibration acoustic detector 31 may be located at any position to receive acoustic signals originating from the calibration acoustic source 30 and the data acquisition acoustic source 15, and reflected from the interface 14.

The presence of the calibration acoustic source 30 and calibration acoustic detector 31 in the embodiment illustrated in FIG. 2a permits the calculation of bottom loss and data acquisition acoustic source signal level. Once these two factors are known, the receive sensitivity of each acoustic detector in the array may be calculated. One example for calculating the receive sensitivity of the data acquisition acoustic detectors will be described with reference to FIG. 2b (which corresponds to FIG. 2a). However, it will be understood that the provision of the calibration acoustic source 30 and calibration acoustic detector 31 may permit alternative derivations for the data acquisition acoustic detector sensitivities. It is the intention of the present invention to encompass all such derivations utilizing the system illustrated in FIG. 2a.

It is important to note that the sensitivity of the calibration acoustic detector is known from accurate laboratory testing. In contrast, the sensitivity of the data acquisition acoustic detector may not be known with any accuracy. For this reason, the calibration system not only permits calculation of bottom loss but also the sensitivity of the data acquisition acoustic source. Any fluctuations in the sensitivity of the data acquisition acoustic source will further be recognized if the data acquisition system is regularly calibrated.

With reference to FIG. 2b, the calibration acoustic source 30 is induced to emit a calibration (first) acoustic signal of an initial level SR_{C} where level is given in decibels (db). The level of SR_{C} generated by the calibration acoustic source is known. For the sake of simplification, the level of SR_{C} will be presumed to be constant for all signals propagated from the calibration signal source. However, it will be understood that similar calculations may be carried out to those described herein, which allow for a change in SR_{C} for each calibration signal.

The calibration acoustic source is triggered to generate SR_{C} by a calibration power transmitter 32 at a known time T_{C}. The incident acoustic signal SR_{C} is directed towards the interface 14 (between the sea 12 and the marine floor 13), which represents the first interface capable of reflecting a significant proportion of the signal S_{RC}. Therefore, part of the signal SR_{C} becomes reflected by interface 14 back towards, and received by, the calibration acoustic detector 31 and amplified by the calibration amplifier 33. As described with reference to FIG. 1, the level of the signal received by the calibration acoustic detector will be different from the initial level SR_{C} for two principle reasons: bottom loss (BL) and transmission loss (N_{WC}) (for simplicity, absorption loss will be considered negligible for the present and subsequent embodiments). In addition, the level, (20*log(level)), of the signal SIG_{C} generated by the calibration acoustic detector 31 and calibration amplifier 33 will depend upon the sensitivity (N_{HC}) of the calibration acoustic detector 31 and the gain (N_{AC}) of the calibration amplifier 33.

In summary, the relationship between the level of the signal transmitted by the calibration acoustic source 30 and the signal SIC_{C} received and outputted by the calibration acoustic detector 31 and the calibration amplifier 32 can be represented by equation 1 below in decibels (db):

SIG_{C}=SR_{C}−N_{WC}+BL+N_{HC}+N_{AC} (1)

wherein:

SIG_{C}=the level of the calibration (first) acoustic signal as received by the calibration acoustic detector and amplified by the calibration amplifier (db)

SR_{C}=the initial level of the calibration acoustic signal transmitted by the calibration acoustic source (db)

N_{WC}=the transmission loss for the calibration acoustic signal (db).

BL=the bottom loss for the reflective interface (db)

N_{HC}=calibration acoustic detector sensitivity (db)

N_{AC}=calibration amplifier gain (db)

The value of SIG_{C}, SR_{C} and N_{HC} are known, since SIG_{C} is the level of the signal received and processed by the calibration system, and SR_{C} and N_{HC} are calibrated by the manufacturer for the calibration acoustic source 30 and calibration acoustic detector 31 under laboratory conditions. N_{AC} can be readily determined with standard testing equipment. N_{WC} can be determined according to equation 2 (wherein Q represents a general value for transmission loss):

Q=20*log(R) (2)

wherein:

Q=Transmission loss (db)

R=Distance travelled by the acoustic signal (m)

R in equation 2 may be calculated according to equation 3:

R=(T_{C}−T_{CR})*V (3)

wherein:

R=Distance travelled by an acoustic signal (m)

T_{C}=Time that the signal is initiated by an acoustic source (s)

T_{CR}=Time that the signal is received by an acoustic detector (s)

V=Velocity of the acoustic signal in the medium (m/s)

Finally, V may be calculated by measuring the time for an acoustic signal to travel directly to acoustic detectors of known distance from the acoustic source. For example, V may be calculated according to equation 4:

V=D/(T_{E1}−T_{E2}) (4)

wherein:

V=Velocity of the acoustic signal in the medium (m/s)

D=Distance travelled by acoustic signal from array acoustic detector E₁, directly to array acoustic detector E₂ (m)

T_{E1}=Time acoustic signal received by acoustic detector E₁

T_{E2}=Time acoustic signal received by acoustic detector E₂

It follows that N_{WC} (equation 1) may be calculated in accordance with equations 2, 3, and 4. Therefore, all factors present in equation 1 are known with the exception of BL. The solution of equation 1 permits calculation of BL.

Next, with reference to FIG. 2b, the initial level of the signal generated by the data acquisition acoustic source 15 may be calculated in accordance with equation 5 below (which corresponds to equation 1):

SIG_{SC}=SR_{S}−N_{WSC}+BL+N_{HC}+N_{AC} (5)

wherein:

SIG_{SC}=the level of the data acquisition (second) acoustic signal as received by the calibration acoustic detector and amplified by the calibration amplifier (db)

SR_{S}=the initial level of the data acquisition acoustic signal transmitted by the data acquisition acoustic source (db)

N_{WSC}=the transmission loss for the data acquisition acoustic signal from the data acquisition acoustic source to the calibration acoustic detector (db)

BL=the bottom loss for the reflective interface (db)

N_{HC}=calibration acoustic detector sensitivity (db)

N_{AC}=calibration amplifier gain (db)

In consideration of equation 5, BL, N_{HC} and N_{AC} may be considered the same as for equation 1. N_{WSC} may be calculated in accordance with equations 2, 3, and 4. SIG_{SC} is a known since this value is the output of the calibration system. Therefore, equation 5 can be solved to calculate SRS. For simplicity, the value of SR_{S} for the present and subsequent embodiments will be presumed constant for all calibration and data acquisition procedures. However, it will be understood that the present invention encompasses a system wherein SR_{S} may fluctuate either intentionally or otherwise, and SR_{S} will require recalculation accordingly.

Finally, an expected receive sensitivity N_{HE} can be calculated for each data acquisition acoustic detector E₁ to E_{N} present in the array of acoustic detectors. For this purpose, the value of BL from equation 1, and the value of SR_{S} from equation 5, can be inserted into equation 6 below (which corresponds to equations 1 and 5). In this way, N_{HE} can be calculated from equation 6, since all factors in equation 6 are known with the exception of N_{HE}. Therefore, equation 6 permits the calculation of the expected receive sensitivity for each data acquisition acoustic detector. For simplification, each data acquisition acoustic amplifier in the array is presumed to have the same gain N_{AC} as the calibration amplifier:

SIG_{S}=SR_{S}−N_{WS}+BL+N_{HE}+N_{AS} (6)

wherein:

SIG_{S}=the level of the data acquisition acoustic signal as received by the data acquisition acoustic detector under examination, and its corresponding amplifier (db)

SR_{S}=the initial level of the data acquisition acoustic signal transmitted by the data acquisition acoustic source (db)

N_{WS}=the transmission loss for the data acquisition acoustic signal from the data acquisition acoustic source to the data acquisition acoustic detector under examination (db)

BL=the bottom loss for the reflective interface (db)

N_{HE}=data acquisition acoustic detector sensitivity (db)

N_{AS}=gain of the amplifier connected to the data acquisition acoustic detector under examination (db)

Therefore, solution of equation 6 permits calculation of N_{HE}, thereby permitting determination of the sensitivity of each acoustic detector in the array.

The N_{HE} value for each acoustic detector in the array can be directly compared to an expected sensitivity value as provided by the manufacturer of the acoustic detector(s). Accordingly, changes can be made to the gain of each corresponding amplifier to compensate for significant anomalies in detector sensitivities. Alternatively, those acoustic detectors that are found to exhibit receive sensitivity values outside quality assurance limits (relative to an expected receive sensitivity value) can be disregarded during subsequent data analysis. These ‘bad’ or malfunctioning acoustic detectors may be replaced at an appropriate time.

An extension of the first embodiment of the present invention can be considered with regard to FIG. 2c, which utilizes the same system illustrated in FIGS. 2a and 2b. FIG. 2c illustrates an alternative means to calculate BL that is independent of the parameters of the hardware (e.g. detector receive sensitivities and amplifier gains). In this regard, two acoustic signal pathways are shown in FIG. 2c from the calibration acoustic source 30 to the calibration acoustic detector 31. The first acoustic signal SIG_{C} is the same as SIG_{C} illustrated in FIG. 2b (shown as a dashed line in FIG. 2c), wherein an acoustic signal is propagated by the calibration acoustic source, and reflected by the interface 14 for detection by the calibration acoustic detector.

The second acoustic signal SIG_{M} (which corresponds to the signal shown as a solid line in FIG. 2c) represents the first ‘multiple signal’ propagated from the calibration acoustic source and received by the calibration acoustic detector. Moreover, SIG_{M} undergoes a total of three reflections: an initial reflection by the interface 14, another reflection by the surface of the water 1, and a final reflection by the interface 14, to ultimately direct the signal towards the calibration acoustic detector. The equation for the calculation of SIG_{M} is shown in equation 7. It is important to note that equation 7 includes 2*BL since SIG_{M} is reflected twice by interface 14. Furthermore, for the purposes of the present example the surface of the water 11 can be considered a near perfect interface for acoustic reflectivity for frequencies used in the marine environment, and therefore equation 7 does not take into account loss of acoustic energy at surface 11.

SIG_{M}=SR_{C}−N_{WM}+2*BL+N_{HC}+N_{AC} (7)

wherein:

SIG_{M}=the level of the first multiple calibration acoustic signal as received by the calibration acoustic detector and amplified by the calibration amplifier (db)

SR_{C}=the initial level of the calibration acoustic signal transmitted by the calibration acoustic source (db)

N_{WM}=the transmission loss for the first multiple calibration acoustic signal (db)

BL=the bottom loss for the reflective interface (db)

N_{HC}=calibration acoustic detector sensitivity (db)

N_{AC}=calibration amplifier gain (db)

Subtraction of equation 7 from equation 1 generates equation 8:

SIG_{C}−SIG_{M}=−N_{WC}+N_{WM}−BL (8)

wherein:

SIG_{C}=the level of the calibration (first) acoustic signal as received by the calibration acoustic detector and amplified by the calibration amplifier (db)

SIG_{M}=the level of the first multiple of the first acoustic signal as received by the calibration acoustic detector and amplified by the calibration amplifier (db)

N_{WC}=the transmission loss for the calibration acoustic signal (db)

N_{WM}=the transmission loss for the first multiple calibration acoustic signal (db)

BL=the bottom loss for the reflective interface (db)

It follows from equation 8 that BL may be calculated independently from hardware parameters (such as detector sensitivity and amplifier gain), since the factors N_{HC} and N_{AC} are eliminated from the equation. It should be noted that the derivation of BL via equation 8 may be less accurate than equation 1. Multiple signals (as shown in FIG. 2c) can exhibit increased noise and spatial divergence resulting from the interference of reflections from deeper interfaces. However, the derivation of BL using equation 8 is expected to provide sufficient calibration accuracy for the majority of applications.

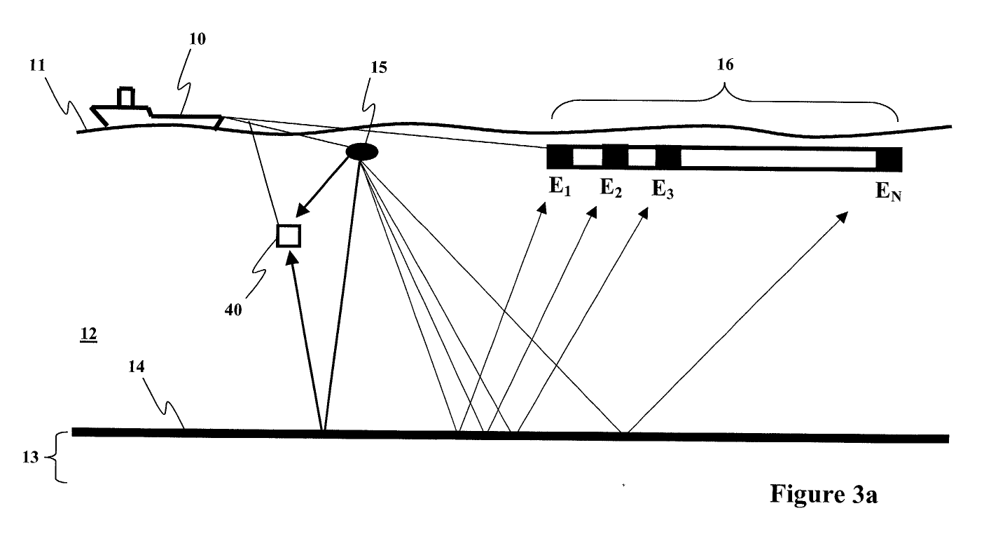

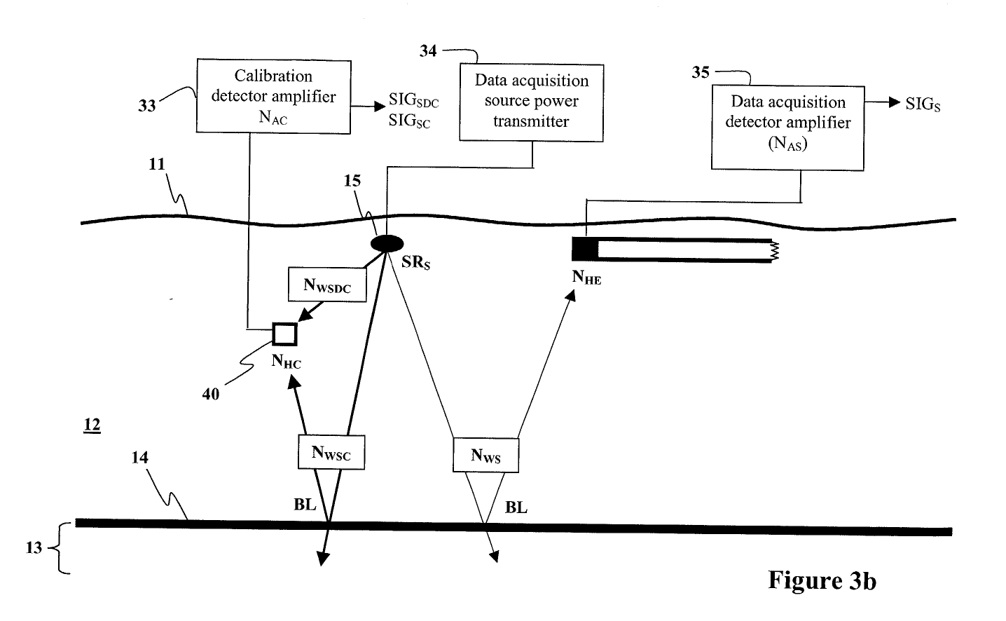

A second embodiment of the present invention is described with reference to FIG. 3. The second embodiment provides a simplified calibration system that uses similar principles to those described for the first embodiment (FIGS. 2a, 2b, and 2c). The system exhibits many features similar to the arrangement shown in FIG. 1 (prior art) and FIG. 2. However, instead of including both a calibration acoustic source and a calibration acoustic detector, only the calibration acoustic detector is included for calibration purposes. In accordance with the first embodiment of the invention, a particular derivation of data acquisition acoustic detector sensitivity will be described for the system, involving the initial calculation of the data acquisition acoustic source signal level followed by a calculation of bottom loss. It will be understood that the system illustrated in FIG. 3 may be used to determine the sensitivity of one or more acoustic detectors via any one of several derivations. It is the intention of the present invention to encompass all such derivations when using the embodiment of the invention illustrated in FIG. 3.

An overview of the system of the second embodiment is illustrated in FIG. 3a. A ship 10 on the surface 11 of the sea 12 is positioned above a region of marine floor 13. The ship is towing a data acquisition acoustic source 15 aft to an array 16 comprising at least one data acquisition acoustic detector (the acoustic detectors being designated E₁ to E_{N}, wherein E₁ is the detector closest to the acoustic source, and E_{N} is the detector positioned farthest from the acoustic source). The ship is also towing a calibration acoustic detector 40 positioned to receive both a direct acoustic signal from the data acquisition acoustic source, and an acoustic signal originating from the data acquisition acoustic source and reflected by the interface 14 between the sea 12 and the marine floor 13. Preferably, the calibration acoustic detector 40 is located lower in the water than the data acquisition acoustic source 15 and the array 16. Without wishing to be bound by theory, it is believed that positioning the calibration acoustic detector in accordance with FIG. 3a may permit the values of bottom loss and data acquisition source signal level to be calculated more accurately as the source level can be monitored.

With reference to FIG. 3b, the data acquisition acoustic source 15 is induced to generate a first acoustic signal of level SR_{S}, and direct the signal SR_{S} towards the calibration acoustic detector 40. The level of the initial signal SR_{S} propagated by the data acquisition acoustic source 15 can be calculated with equation 9:

SIG_{SDC}=SR_{S}−N_{WSDC}+N_{HC}+N_{AC} (9)

wherein:

SIG_{SDC}=the level of the first acoustic signal as received by the calibration acoustic detector and amplified by the calibration amplifier (db)

SR_{S}=the initial level of the first acoustic signal transmitted by the data acquisition acoustic source (db)

N_{WSDC}=the transmission loss for the first acoustic signal during transmission from the data acquisition acoustic source directly to the calibration acoustic detector (db)

N_{HC}=calibration acoustic detector sensitivity (db)

N_{AC}=calibration amplifier gain (db)

It is important to note that equation 9 does not include factor BL since the acoustic signal travels directly from the data acquisition acoustic source to the calibration acoustic detector. The first data acquisition acoustic signal is not reflected by interface 14, and therefore bottom loss is not a consideration in this instance. As described previously for the first embodiment, N_{HC} and N_{AC} relate to known properties of the calibration system. Moreover, SIG_{SDC} is a known value from the output of the calibration system, and N_{WSDC} may be calculated in accordance with equations 2 to 4. Therefore, the solution of equation 9 permits the calculation of SR_{S}.

Once SR_{S} is known from equation 9, a value for BL may be calculated by consideration of the second acoustic signal indicated in FIG. 3b. The second acoustic signal may be same original signal propagated by the data acquisition acoustic source as the first acoustic signal. Alternatively, the second acoustic signal may be a temporally separate signal. In any event, the initial level of the first and second signals (upon propagation from the data acquisition acoustic source) will be considered the same for the sake of simplicity. It therefore follows that BL may be calculated by solving equation 10:

SIG_{SC}=SR_{S}−N_{WSC}+BL+N_{HC}+N_{AC} (10)

wherein:

SIG_{SC}=the level of the second acoustic signal as received by the calibration acoustic detector and amplified by the calibration amplifier (db)

SR_{S}=the initial level of the second (and first) acoustic signal transmitted by the data acquisition acoustic source (db)

N_{WSC}=the transmission loss for the second acoustic signal during transmission from the data acquisition acoustic source, and reflection to the calibration acoustic detector (db)

N_{HC}=calibration acoustic detector sensitivity (db)

N_{AC}=calibration amplifier gain (db)

Therefore, in accordance with the first embodiment of the invention, N_{HC} and N_{AC} are properties of the calibration system, and these values are therefore known with accuracy. SR_{S} is known from equation 9, SIG_{SC} is known from the output of the calibration system, and N_{WSC} may be calculated in accordance with equations 2 to 4. Therefore, BL can be derived from equation 10.

The embodiment of the invention illustrated in FIG. 3b can also permit calculation of both SR_{S} and BL by suitable derivations. It follows that these values can be inserted into equation 6. All factors in equation 6 are known or can be calculated, with the exception Of N_{HE}; the receive sensitivity of the data acquisition acoustic detector under examination. Therefore, solution of equation 6 permits calculation of N_{HE} , thereby permitting determination of the sensitivity of each acoustic detector in the array.

The N_{HE} value for each acoustic detector in the array can be directly compared to an expected sensitivity value as provided by the manufacturer of the acoustic detector(s). Accordingly, changes can be made to the gain of each corresponding amplifier to allow for correction of significant anomalies in detector sensitivities. Alternatively, those acoustic detectors that are found to exhibit receive sensitivity values outside quality assurance limits (relative to an expected receive sensitivity value) can be disregarded during subsequent data analysis. These ‘bad’ or malfunctioning acoustic detectors may be replaced at an appropriate time.

In a third embodiment of the present invention, the principles described with reference to the first and second embodiments are applied to the original system illustrated in FIG. 1. Therefore, the third embodiment is considered particularly suitable as an economic alternative to the first two embodiments since additional equipment (such as calibration acoustic sources and detectors) is not required over the data acquisition acoustic source and array of detectors. Moreover, the third embodiment may provide an especially useful method for situations when calibration hardware cannot be deployed and a relative acoustic receiver sensitivity output is sufficient to provide a gross overview of array status. A typical situation of this kind includes extreme sea states during marine applications, or land applications where the calibration hardware cannot be used for fear of damage or deployment difficulties. However, it is important to note that this embodiment only permits reasonable estimation of acoustic detector sensitivities, and therefore may be considered less accurate compared to the systems and methods disclosed in embodiments one and two.

In accordance with embodiments one and two, the third embodiment of the present invention requires that BL and SR_{S} are calculated initially, to permit analysis of data acquisition acoustic detector receive sensitivities. However, due to the constrains of the simplified system, BL must be estimated using a data acquisition acoustic detector (of unknown sensitivity), and following BL estimation, SR_{S} may be estimated using an expected average value for the data acquisition acoustic detector receiving sensitivities.

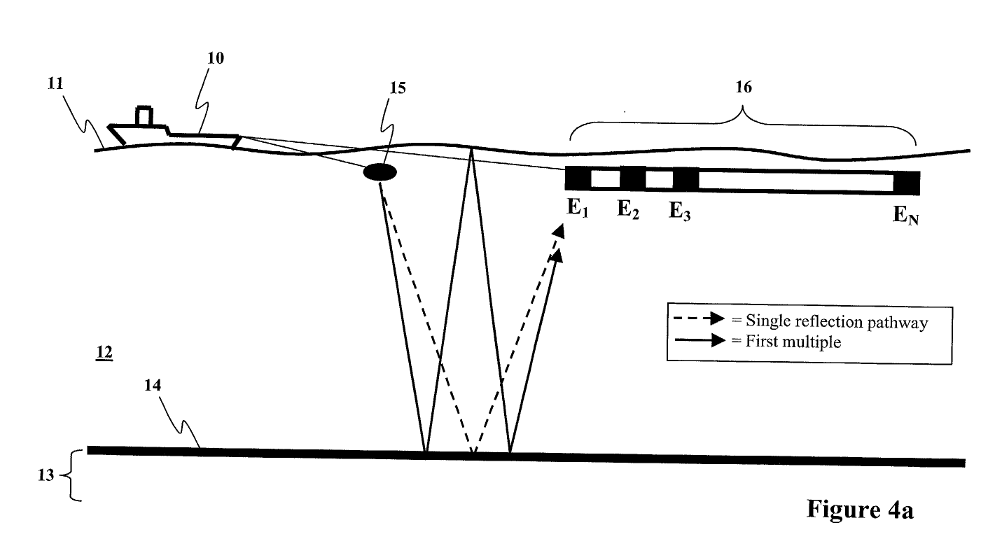

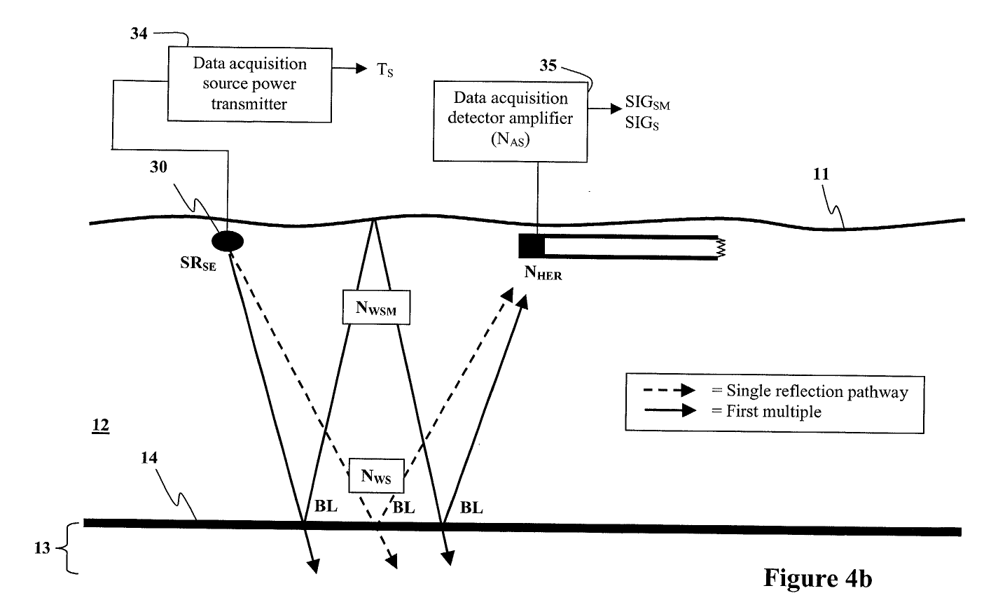

An overview of the third embodiment is illustrated with reference to FIG. 4a. The arrangement of the two acoustic signal pathways is similar to that shown in FIG. 2c (embodiment one) having regard to SIG_{C} and the first multiple SIG_{M}. However, consideration of FIG. 2c enabled calculation of BL via equation 8 using signals received by the calibration acoustic detector 30 (with known parameters of sensitivity). In contrast, the embodiment shown in FIG. 4a permits BL to be estimated using signals received by one of the data acquisition acoustic receivers, for example E₁ (with unknown parameters regarding sensitivity). With reference to FIG. 4b, BL can be estimated via equation 11, which corresponds to equation 8.

SIG_{S}−SIG_{SM}−N_{WS}+N_{WSM}−BL_{(ESTIMATED)} (11)

wherein:

SIG_{S}=the level of the first acoustic signal as received by a data acquisition acoustic detector of choice, and amplified by its corresponding amplifier (db)

SIG_{SM}=the level of the first multiple of the first acoustic signal as received by the data acquisition acoustic detector of choice, and amplified by its corresponding amplifier (db)

N_{WS}=the transmission loss for the first acoustic signal (db)

N_{WSM}=the transmission loss for the first multiple of the first acoustic signal (db)

BL_{(ESTIMATED)}=the estimated bottom loss for the reflective interface (db)

An estimated value for BL can therefore be calculated by solving equation 11.

As already mentioned, an estimation of SR_{S} can be calculated using the estimated value for BL in accordance with equation 12 (derived from equation

SIG_{S}=SR_{S(ESTIMATED)}−N_{WS}+BL_{(ESTIMATED)}+N_{HEM}+N_{AS} (12)

wherein:

SIG_{S}=the level of the first acoustic signal as received by the data acquisition acoustic detector of choice, and amplified by its corresponding amplifier (db)

SR_{S(ESTIMATED)}=the estimated initial level of the first acoustic signal transmitted by the data acquisition acoustic source (db)

N_{WS}=the transmission loss for the first acoustic signal (db)

BL_{(ESTIMATED)}=the estimated bottom loss for the reflective interface (db)

N_{HEM}=the estimated average data acquisition acoustic detector sensitivity, as determined for example by the manufacturers specifications (db)

N_{AS}=data acquisition amplifier gain (db)

SIG_{S} is a known factors, since the value of SIG_{S} is the output of the data acquisition acoustic detector and amplifier. N_{WS} may be calculated in accordance with equations 2 to 4, and the value of BL_{(ESTIMATED)} can be used from equation 11. N_{HEM} can be estimated from the manufacturers specifications for the data acquisition acoustic detectors, and N_{AS} can also be readily calculated from standard techniques. Therefore, solution of equation 12 permits calculation of an estimated value for SR_{S}. Furthermore, the estimated values for BL (equation 11) and SR_{S} (equation 12) can be inserted into equation 13 to calculate an expected sensitivity for each data acquisition acoustic detector:

SIG_{S}=SR_{S(ESTIMATED)}−N_{WS}+BL_{(ESTIMATED)}+N_{HER}+N_{AS} (13)

wherein:

SIG_{S}=the level of the first acoustic signal as received by the data acquisition acoustic detector of choice, and amplified by its corresponding amplifier (db)

SR_{S(ESTIMATED)}=the estimated initial level of the first acoustic signal transmitted by the data acquisition acoustic source (db)

N_{WS}=the transmission loss for the acoustic signal (db)

BL_{(ESTIMATED)}=the estimated bottom loss for the reflective interface (db)

N_{HER}=the estimated data acquisition acoustic detector sensitivity, which may be recalculated for each data acquisition acoustic detector (db)

N_{AS}=data acquisition amplifier gain (db)

Therefore, by solving equation 13 in accordance with equation 12, an estimated receive sensitivity can be assigned to each data acquisition acoustic detector in the array. The estimated receive sensitivity values can be directly compared with the expected received sensitivities for each data acquisition acoustic detector (for example, as indicated by the manufacturer) and corrections can be made accordingly. If the receive sensitivity is significantly different from the expected receive sensitivity, then the operator of the system may elect to disregard the data collected by the malfunctioning detector during data integration and analysis.

It is important to note that normally each data acquisition acoustic detector is connected to a separate amplifier. However, for the purposes of clarifying the novel features of the present invention, each amplifier is assumed to have the same gain. In this way, the embodiments of the present invention have been described in simplistic terms, and additional modifications and corrections will be required for calibration of acoustic detectors in the field.

While the invention has been described with reference to particular preferred embodiments thereof, it will be apparent to those skilled in the art upon a reading and understanding of the foregoing that numerous acoustic and EM detector calibration systems and methods related to the specific embodiments illustrated are attainable, which nonetheless lie within the spirit and scope of the present invention. It is intended to include all such designs, and equivalents thereof within the scope of the appended claims.

1. A system for calibrating at least one data acquisition acoustic or EM detector arranged in an array, the system comprising:
a calibration acoustic or EM source, capable of generating an acoustic or EM signal of known level;
a calibration acoustic or EM detector of known sensitivity;
a data acquisition acoustic or EM source;
wherein said calibration acoustic or EM source directs a first acoustic or EM signal to a reflective interface, said first acoustic or EM signal being reflected by said reflective interface and detected by said calibration acoustic or EM detector, thereby permitting calculation of a bottom loss value at the reflective interface;
said data acquisition acoustic or EM source directs a second acoustic or EM signal to said reflective interface, said second acoustic or EM signal being reflected by said reflective interface and detected by said calibration acoustic or EM detector, thereby permitting calculation of a level of said second acoustic or EM signal upon initial transmission;
said at least one data acquisition acoustic or EM detector detecting further acoustic or EM signals generated by said data acquisition acoustic or EM source and reflected by said reflective interface, thereby permitting calculation of a sensitivity of said at least one data acquisition acoustic or EM detector.

2. The system according to claim 1, wherein the sensitivity of said at least one data acquisition acoustic or EM detector is compared to an expected sensitivity of said at least one data acquisition acoustic or EM detector, and adjustments made to amplifiers for each of said at least one data acquisition acoustic or EM detector to compensate for a difference between said sensitivity and said expected sensitivity.

3. The system according to claim 1, wherein a difference is determined between the sensitivity of said at least one data acquisition acoustic or EM detector and an expected sensitivity of said at least one data acquisition acoustic or EM detector, and an acoustic or EM detector selected from said at least one data acquisition acoustic or EM detector is disregarded from said array if said difference is larger than a predetermined deviation.

4. The system according to claim 1, wherein said bottom loss is calculated according to equation:
SIG_{C}=SR_{C}−N_{WC}+BL+N_{HC}+N_{AC}
wherein:
SIG_{C}=the level of the first acoustic or EM signal as received by the calibration acoustic or EM detector and amplified by the calibration amplifier (db)
SR_{C}=the initial level of the first acoustic or EM signal transmitted by the calibration acoustic or EM source (db)
N_{WC}=the transmission loss for the first acoustic or EM signal (db)
BL=the bottom loss for the reflective interface (db)
N_{HC}=calibration acoustic or EM detector sensitivity (db)
N_{AC}=calibration amplifier gain (db)

5. The system according to claim 4, wherein said transmission loss is calculated according to equation:
Q=20*log(R)
wherein:
Q=Transmission loss (db)
R=Distance travelled by the acoustic or EM signal (m)

6. The system according to claim 1, wherein said calibration acoustic or EM detector further receives a first multiple of said first acoustic or EM signal and said bottom loss is calculated according to equation:
SIG_{C}−SIG_{M}=−N_{WC}+N_{WM}−BL
wherein:
SIG_{C}=the level of the first acoustic or EM signal as received by the calibration acoustic or EM detector and amplified by the calibration amplifier (db)
SIG_{M}=the level of the first multiple of the first acoustic or EM signal as received by the calibration acoustic or EM detector and amplified by the calibration amplifier (db)
N_{WC}=the transmission loss for the first acoustic or EM signal (db)
N_{WM}=the transmission loss for the first multiple of the first acoustic or EM signal (db)
BL=the bottom loss for the reflective interface (db)

7. The system according to claim 6, wherein said transmission loss is calculated according to equation:
Q=20*log(R)
wherein:
Q=Transmission loss (db)
R=Distance travelled by the acoustic or EM signal (m)

8. The system according to claim 4, wherein the initial level of the second acoustic or EM signal is calculated according to equation:
SIG_{SC}=SR_{S}−N_{WSC}+BL+N_{HC}+N_{AC}
wherein:
SIG_{SC}=the level of the second acoustic or EM signal as received by the calibration acoustic or EM detector and amplified by the calibration amplifier (db)
SR_{S}=the initial level of the second acoustic or EM signal transmitted by the data acquisition acoustic or EM source (db)
N_{WSC}=the transmission loss for the second acoustic or EM signal from the data acquisition acoustic or EM source to the calibration acoustic or EM detector (db)
BL=the bottom loss for the reflective interface (db)
N_{HC}=calibration acoustic or EM detector sensitivity (db)
N_{AC}=calibration amplifier gain (db)

9. The system according to claim 8, wherein the sensitivity of each data acquisition acoustic or EM detector is calculated according to equation:
SIG_{S}=SR_{S}−N_{WS}+BL+N_{HE}+N_{AS}
wherein:
SIG_{S}=the level of further acoustic or EM signals (propagated by the data acquisition acoustic or EM source) as received by the data acquisition acoustic or EM detector under examination, and its corresponding amplifier (db)
SR_{S}=the initial level of the further acoustic or EM signal(s) transmitted by the data acquisition acoustic or EM source (db)
N_{WS}=the transmission loss for the further acoustic or EM signal(s) from the data acquisition acoustic or EM source to the data acquisition acoustic or EM detector under examination (db)
BL=the bottom loss for the reflective interface (db)
N_{HE}=data acquisition acoustic or EM detector sensitivity (db)
N_{AS}=gain of the amplifier connected to the data acquisition acoustic or EM detector under examination (db)

10. The system according to claim 1, wherein the reflective interface is a marine floor or river bed, and said array of acoustic or EM detectors are located beneath the surface of a body of water.

11. A system for calibrating at least one data acquisition acoustic or EM detector arranged in an array, the system comprising:
a calibration acoustic or EM detector of known sensitivity;
a data acquisition acoustic or EM source;
wherein said data acquisition acoustic or EM source directs a first acoustic or EM signal to said calibration acoustic or EM detector, thereby permitting calculation of an initial level of said first acoustic or EM signal upon propagation from said data acquisition acoustic or EM source;
said data acquisition acoustic or EM source directs a second acoustic or EM signal to a reflective interface, said second acoustic or EM signal being reflected by said reflective interface and detected by said calibration acoustic or EM detector, thereby permitting calculation of a bottom loss value at said reflective interface;
said at least one data acquisition acoustic or EM detector detecting further acoustic or EM signals generated by said data acquisition acoustic or EM source and reflected by said reflective interface, thereby permitting calculation of a sensitivity for said at least one data acquisition acoustic or EM detector.

12. The system according to claim 11, wherein the sensitivity of said at least one data acquisition acoustic or EM detector is compared to an expected sensitivity of said at least one data acquisition acoustic or EM detector, and adjustments made to amplifiers for each of said at least one data acquisition acoustic or EM detector to compensate for a difference between said sensitivity and said expected sensitivity.

13. The system according to claim 11, wherein a difference is determined between the sensitivity of said at least one data acquisition acoustic or EM detector and an expected sensitivity of said at least one data acquisition acoustic or EM detector, and an acoustic or EM detector selected from said at least one data acquisition acoustic or EM detector is disregarded from said array if said difference is larger than a predetermined deviation.

14. The system according to claim 11, wherein the level of the first acoustic or EM signal is calculated according to equation:
SIG_{SDC}=SR_{S}−N_{WSDC}+N_{HC}+N_{AC}
wherein:
SIG_{SDC}=the level of the first acoustic or EM signal as received by the calibration acoustic or EM detector and amplified by the calibration amplifier (db)
SR_{S}=the initial level of the first acoustic or EM signal transmitted by the data acquisition acoustic or EM source (db)
N_{WSDC}=the transmission loss for the first acoustic or EM signal during transmission from the data acquisition acoustic or EM source directly to the calibration acoustic or EM detector (db)
N_{HC}=calibration acoustic or EM detector sensitivity (db)
N_{AC}=calibration amplifier gain (db)

15. The system according to claim 14, wherein said bottom loss is calculated according to equation:
SIG_{SC}=SR_{S}−N_{WSC}+BL+N_{HC}+N_{AC}
wherein:
SIG_{SC}=the level of the second acoustic or EM signal as received by the calibration acoustic or EM detector and amplified by the calibration amplifier (db)
SR_{S}=the initial level of the second (and first) acoustic or EM signal transmitted by the data acquisition acoustic or EM source (db)
N_{WSC}=the transmission loss for the second acoustic or EM signal during transmission from the data acquisition acoustic or EM source, and reflection to the calibration acoustic or EM detector (db)
BL=the bottom loss for the reflective interface (db)
N_{HC}=calibration acoustic or EM detector sensitivity (db)
N_{AC}=calibration amplifier gain (db)

16. The system according to claim 15, wherein said transmission loss is calculated according to equation:
Q=20*log(R)
wherein:
Q=Transmission loss (db)
R=Distance travelled by the acoustic or EM signal (m)

17. The system according to claim 16, wherein the sensitivity of each data acquisition acoustic or EM detector is calculated according to equation:
SIG_{S}=SR_{S}−N_{WS}+BL+N_{HE}+N_{AS}
wherein:
SIG_{S}=the level of a further acoustic or EM signal as received by the data acquisition acoustic or EM detector under examination, and its corresponding amplifier (db)
SR_{S}=the initial level of the further acoustic or EM signal transmitted by the data acquisition acoustic or EM source (db)
N_{WS}=the transmission loss for the further acoustic or EM signal from the data acquisition acoustic or EM source to the data acquisition acoustic or EM detector under examination (db)
BL=the bottom loss for the reflective interface (db)
N_{HE}=data acquisition acoustic or EM detector sensitivity (db)
N_{AS}=gain of the amplifier connected to the data acquisition acoustic or EM detector under examination (db)

18. The system according to claim 11, wherein said first and second acoustic or EM signals are propagated simultaneously.

19. The system according to claim 11, wherein said first and second acoustic or EM signals are propagated sequentially.

20. The system according to claim 11, wherein the reflective interface is a marine floor or river bed, and said array of acoustic or EM detectors are located beneath the surface of a body of water.

21. A system for calibrating each acoustic or EM detector in an array comprising at least two acoustic or EM detectors, the system comprising:
a data acquisition acoustic or EM source;
wherein said data acquisition acoustic or EM source directs a first acoustic or EM signal of an initial level to a first reflective interface, said first acoustic or EM signal being reflected by said first reflective interface and detected by a particular data acquisition acoustic or EM detector within said array;
said data acquisition acoustic or EM source directs a second acoustic or EM signal to said first reflective interface, said second acoustic or EM signal reflected by said first reflective interface to a second reflective interface and reflected by said second reflective interface back to said first reflective interface, said first reflective interface reflecting said second acoustic or EM signal to said particular data acquisition acoustic or EM detector;
said difference in level of said first and second signals when received by said particular data acquisition acoustic or EM detector thereby permitting:
(a) estimation of a bottom loss value;
(b) estimation of the initial level for the first and second acoustic or EM signals; and
(c) calculation of an estimated sensitivity of each of said at least one data acquisition acoustic or EM detectors.

22. The system according to claim 21, wherein the sensitivity of said at least one data acquisition acoustic or EM detector is compared to an expected sensitivity of said at least one data acquisition acoustic or EM detector, and adjustments made to amplifiers for each of said at least one data acquisition acoustic or EM detector to compensate for a difference between said sensitivity and said expected sensitivity.

23. The system according to claim 21, wherein a difference is determined between the sensitivity of said at least one data acquisition acoustic or EM detector and an expected sensitivity of said at least one data acquisition acoustic or EM detector, and an acoustic or EM detector selected from said at least one data acquisition acoustic or EM detector is disregarded from said array if said difference is larger than a predetermined range.

24. The system according to claim 21, wherein the first reflective interface is a marine floor or a river bed, and the second reflective interface is a water/air interface.

25. The system according to claim 24, wherein said estimated bottom loss is calculated according to equation:
SIG_{S}−SIG_{SM}−N_{WS}+N_{WSM}−BL_{(ESTIMATED)}
wherein:
SIG_{S}=the level of the first acoustic or EM signal as received by a data acquisition acoustic or EM detector of choice, and amplified by its corresponding amplifier (db)
SIG_{SM}=the level of the first multiple of the second acoustic or EM signal as received by the data acquisition acoustic or EM detector of choice, and amplified by its corresponding amplifier (db)
N_{WS}=the transmission loss for the first acoustic or EM signal (db)
N_{WSM}=the transmission loss for the first multiple of the second acoustic or EM signal (db)
BL_{(ESTIMATED)}=the estimated bottom loss for the reflective interface (db)

26. The system according to claim 25, wherein the transmission loss is calculated according to equation:
Q=20*log(R)
wherein:
Q=Transmission loss (db)
R=Distance travelled by the acoustic or EM signal (m)

27. The system according to claim 26, wherein the estimated initial level of the first acoustic or EM signal is calculated according to equation 12:
SIG_{S}=SR_{S(ESTIMATED)}−N_{WS}+BL_{(ESTIMATED)}+N_{HEM}+N_{AS} (12)
wherein:
SIG_{S}=the level of the first acoustic or EM signal as received by the data acquisition acoustic or EM detector of choice, and amplified by its corresponding amplifier (db)
SR_{S(ESTIMATED)}=the estimated initial level of the first acoustic or EM signal transmitted by the data acquisition acoustic or EM source (db)
N_{WS}=the transmission loss for the data acquisition acoustic or EM signal (db)
BL_{(ESTIMATED)}=the estimated bottom loss for the reflective interface (db)
N_{HEM}=the estimated average data acquisition acoustic or EM detector sensitivity, as determined for example by the manufacturers specifications (db)
N_{AS}=data acquisition amplifier gain (db)

28. The system according to claim 27, wherein the sensitivity of said at least one data acquisition acoustic or EM source is calculated according to equation:
SIG_{S}=SR_{S(ESTIMATED)}−N_{WS}+BL_{(ESTIMATED)}+N_{HER}+N_{AS}
wherein:
SIG_{S}=the level of the first (or subsequent) acoustic or EM signal as received by the data acquisition acoustic or EM detector of choice, and amplified by its corresponding amplifier (db)
SR_{S(ESTIMATED)=the estimated initial level of the first (or subsequent) acoustic or EM signal transmitted by the data acquisition acoustic or EM source (db)}
N_{WS}=the transmission loss for the acoustic or EM signal (db)
BL_{(ESTIMATED)}=the estimated bottom loss for the reflective interface (db)
N_{HER}=the estimated data acquisition acoustic or EM detector sensitivity, which may be recalculated for each data acquisition acoustic or EM detector (db)
N_{AS}=data acquisition amplifier gain (db)

29. The system according to claim 21, wherein the first signal and the second signal are propagated simultaneously.

30. The system according to claim 21, wherein the first signal and the second signal are propagated sequentially.

31. A method for determining a sensitivity of at least one acoustic or EM detector, wherein the at least one acoustic or EM detector is located to receive an acoustic or EM signal reflected by a reflective interface, the method comprising the steps of:
(a) determining a bottom loss value of acoustic or EM energy not reflected by the reflective interface;
(b) determining a level of said acoustic or EM signal upon initial transmission;
(c) using the bottom loss value and the level of the acoustic or EM signal upon initial transmission, and a level of an acoustic or EM signal received by said at least one acoustic or EM detector, to determine the sensitivity of said at least one acoustic or EM detector.

32. The method according to claim 31, further comprising the steps of:
(d) comparing the sensitivity of said at least one acoustic or EM detector with an expected sensitivity for said at least one acoustic or EM detector; and
(e) adjusting at least one corresponding amplifier for each of said at least one acoustic or EM detector to compensate for a difference between said sensitivity and said expected sensitivity.

33. The method according to claim 31, further comprising the steps of:
(d) comparing the sensitivity of said at least one acoustic or EM detector with an expected sensitivity for said at least one acoustic or EM detector; and
(e) determining an acceptable standard deviation range for said sensitivity of said at least one acoustic or EM detector; and
(f) disregarding any acoustic or EM detector in said at least one acoustic or EM detector, that has a sensitivity greater than or less than said standard deviation range.

34. A method of calibrating at least one acoustic or EM detector, comprising the steps of:
(a) directing a first incident acoustic or EM signal of known initial level from a calibration acoustic or EM source to a reflective interface;
(b) detecting a first reflected acoustic or EM signal derived from said first incident acoustic or EM signal being reflected by said reflective interface, and detected by a calibration acoustic or EM detector of known sensitivity;
(c) calculating a bottom loss value for said reflective interface;
(d) directing a second incident acoustic or EM signal of unknown level from a data acquisition acoustic or EM source to said reflective interface;
(e) detecting a second reflected acoustic or EM signal derived from said second incident acoustic or EM signal being reflected by said reflective interface, and detected by said calibration acoustic or EM detector of known sensitivity;
(f) calculating an initial level for said second incident acoustic or EM signal;
(g) directing at least one subsequent incident acoustic or EM signal from said data acquisition acoustic or EM source to said reflective interface, said at least one subsequent incident acoustic or EM signals being reflected by said reflective interface and detected by said at least one data acquisition acoustic or EM detector; and
(h) using said bottom loss value and said initial level for said second incident acoustic or EM signal to calculate a sensitivity for said at least one acoustic or EM detector.

35. The method according to claim 34, further comprising the steps of:
(i) comparing the sensitivity of said at least one acoustic or EM detector with an expected sensitivity for said at least one acoustic or EM detector; and
(j) adjusting at least one corresponding amplifier for each of said at least one acoustic or EM detector to compensate for a difference between said sensitivity and said expected sensitivity.

36. The method according to claim 34, further comprising the steps of:
(i) comparing the sensitivity of said at least one acoustic or EM detector with an expected sensitivity for said at least one acoustic or EM detector; and
(j) determining an acceptable standard deviation range for said sensitivity of said at least one acoustic or EM detector; and
(k) disregarding any acoustic or EM detector in said at least one acoustic or EM detector, that has a sensitivity greater than or less than said standard deviation range.

37. A method of calibrating at least one acoustic or EM detector in an array of acoustic or EM detectors, comprising the steps of:
(a) directing a first incident acoustic or EM signal of unknown level from a data acquisition acoustic or EM source to a calibration acoustic or EM detector of known sensitivity;
(b) detecting said first incident acoustic or EM signal with said calibration acoustic or EM detector;
(c) calculating an initial level of said first incident acoustic or EM signal;
(d) directing a second incident acoustic or EM signal from said data acquisition source to a reflective interface;
(e) detecting a reflected acoustic or EM signal derived from said second incident acoustic or EM signal, with said calibration acoustic or EM detector of known sensitivity;
(f) calculating a bottom loss value for said reflective interface;
(g) directing at least one subsequent incident acoustic or EM signal from said data acquisition acoustic or EM source to said reflective interface, said at least one subsequent incident acoustic or EM signals being reflected by said reflective interface and detected by said at least one data acquisition acoustic or EM detector; and
(h) using said bottom loss value, said initial level for said first incident acoustic or EM signal, and a level of an acoustic signal received by said at least one acoustic or EM detector, to calculate a sensitivity for said at least one acoustic or EM detector.

38. The method according to claim 37, further comprising the steps of:
(i) comparing the sensitivity of said at least one acoustic or EM detector with an expected sensitivity for said at least one acoustic or EM detector; and
(j) adjusting at least one corresponding amplifier for each of said at least one acoustic or EM detector to compensate for a difference between said sensitivity and said expected sensitivity.

39. The method according to claim 37, further comprising the steps of:
(i) comparing the sensitivity of said at least one acoustic or EM detector with an expected sensitivity for said at least one acoustic or EM detector; and
(j) determining an acceptable standard deviation range for said sensitivity of said at least one acoustic or EM detector; and
(k) disregarding any acoustic or EM detector in said at least one acoustic or EM detector, that has a sensitivity greater than or less than said standard deviation range.

40. A method of calibrating at least two acoustic or EM detectors arranged in an array, comprising the steps of:
(a) directing an incident acoustic or EM signal of unknown level from an acoustic or EM source to a reflective interface;
(b) detecting a first reflected acoustic or EM signal derived from said incident acoustic or EM signal being reflected once from said reflective interface, said first reflected acoustic or EM signal detected by a particular acoustic or EM detector in said array;
(c) detecting a second reflected acoustic or EM signal derived from said incident acoustic or EM signal being reflected twice from said reflective interface, said second reflected acoustic or EM signal detected by said particular acoustic or EM detector in said array;
(d) calculating a difference in level between said first and second reflected acoustic or EM signals as received by said particular acoustic or EM detector;
(e) calculating a bottom loss value for said incident acoustic or EM signal at said reflective interface;
(f) estimating a mean sensitivity for said at least two acoustic or EM detectors in said array;
(g) calculating an estimated initial level of said incident acoustic or EM signal;
(h) directing at least one subsequent incident acoustic or EM signal from said data acquisition acoustic or EM source to said reflective interface, said at least one subsequent incident acoustic or EM signal being reflected by said reflective interface and detected by said at least two acoustic or EM detectors; and
(i) calculating an estimated sensitivity for each of said at least two acoustic or EM detectors in said array.

41. The method according to claim 40, further comprising the steps of:
(j) comparing the estimated sensitivity of said at least one acoustic or EM detector with an expected sensitivity for said at least one acoustic or EM detector; and
(k) adjusting at least one corresponding amplifier for each of said at least one acoustic or EM detector to compensate for a difference between said estimated sensitivity and said expected sensitivity.

42. The method according to claim 40, further comprising the steps of:
(j) comparing the estimated sensitivity of said at least one acoustic or EM detector with an expected sensitivity for said at least one acoustic or EM detector; and
(k) determining an acceptable standard deviation range for said estimated sensitivity of said at least two acoustic or EM detectors; and
(l) disregarding any acoustic or EM detector in said at least two acoustic or EM detectors, that has an estimated sensitivity greater than or less than said standard deviation range.

43. The system according to claim 5, wherein the initial level of the second acoustic or EM signal is calculated according to equation:
SIG_{SC}=SR_{S}−N_{WSC}+BL+N_{HC}+N_{AC}
wherein:
SIG_{SC} the level of the second acoustic or EM signal as received by the calibration acoustic or EM detector and amplified by the calibration amplifier (db)
SR_{S}=the initial level of the second acoustic or EM signal transmitted by the data acquisition acoustic or EM source (db)
N_{WSC}=the transmission loss for the second acoustic or EM signal from the data acquisition acoustic or EM source to the calibration acoustic or EM detector (db)
BL=the bottom loss for the reflective interface (db)
N_{HC}=calibration acoustic or EM detector sensitivity (db)
N_{AC}=calibration amplifier gain (db)

44. The system according to claim 43, wherein the sensitivity of each data acquisition acoustic or EM detector is calculated according to equation:
SIG_{S}=SR_{S}−N_{WS}+BL+N_{HE}+N_{AS}
wherein:
SIG_{S}=the level of further acoustic or EM signals (propagated by the data acquisition acoustic or EM source) as received by the data acquisition acoustic or EM detector under examination, and its corresponding amplifier (db)
SR_{S}=the initial level of the further acoustic or EM signal transmitted by the data acquisition acoustic or EM source (db)
N_{WS}=the transmission loss for the further acoustic or EM signal(s) from the data acquisition acoustic or EM source to the data acquisition acoustic or EM detector under examination (db)
BL the bottom loss for the reflective interface (db)
N_{HE}=data acquisition acoustic or EM detector sensitivity (db)
N_{AS}=gain of the amplifier connected to the data acquisition acoustic or EM detector under examination (db)

45. The system according to claim 6, wherein the initial level of the second acoustic or EM signal is calculated according to equation:
SIG_{SC}=SR_{S}−N_{WSC}+BL+N_{HC}+N_{AC}
wherein:
SIG_{SC}=the level of the second acoustic or EM signal as received by the calibration acoustic or EM detector and amplified by the calibration amplifier (db)
SR_{S}=the initial level of the second acoustic or EM signal transmitted by the data acquisition acoustic or EM source (db)
N_{WSC}=the transmission loss for the second acoustic or EM signal from the data acquisition acoustic or EM source to the calibration acoustic or EM detector (db)
BL=the bottom loss for the reflective interface (db)
N_{HC}=calibration acoustic or EM detector sensitivity (db)
N_{AC}=calibration amplifier gain (db)

46. The system according to claim 45, wherein the sensitivity of each data acquisition acoustic or EM detector is calculated according to equation:
SIG_{S}=SR_{S}−N_{WS}+BL+N_{HE}+N_{AS}
wherein:
SIG_{S}=the level of further acoustic or EM signals (propagated by the data acquisition acoustic or EM source) as received by the data acquisition acoustic or EM detector under examination, and its corresponding amplifier (db)
SR_{S}=the initial level of the further acoustic or EM signal transmitted by the data acquisition acoustic or EM source (db)
N_{WS}=the transmission loss for the further acoustic or EM signal(s) from the data acquisition acoustic or EM source to the data acquisition acoustic or EM detector under examination (db)
BL=the bottom loss for the reflective interface (db)
N_{HE}=data acquisition acoustic or EM detector sensitivity (db)
N_{AS} =gain of the amplifier connected to the data acquisition acoustic or EM detector under examination (db)

47. The system according to claim 7, wherein the initial level of the second acoustic or EM signal is calculated according to equation:
SIG_{SC}=SR_{S}−N_{WSC}+BL+N_{HC}+N_{AC}
wherein:
SIG_{SC}=the level of the second acoustic or EM signal as received by the calibration acoustic or EM detector and amplified by the calibration amplifier (db)
SR_{S}=the initial level of the second acoustic or EM signal transmitted by the data acquisition acoustic or EM source (db)
N_{WSC}=the transmission loss for the second acoustic or EM signal from the data acquisition acoustic or EM source to the calibration acoustic or EM detector (db)
BL=the bottom loss for the reflective interface (db)
N_{HC}=calibration acoustic or EM detector sensitivity (db)
N_{AC}=calibration amplifier gain (db)

48. The system according to claim 47, wherein the sensitivity of each data acquisition acoustic or EM detector is calculated according to equation:
SIG_{S}=SR_{S}−N_{WS}+BL+N_{HE}+N_{AS}
wherein:
SIG_{S}=the level of further acoustic or EM signals (propagated by the data acquisition acoustic or EM source) as received by the data acquisition acoustic or EM detector under examination, and its corresponding amplifier (db)
SR_{S}=the initial level of the further acoustic or EM signal transmitted by the data acquisition acoustic or EM source (db)
N_{WS}=the transmission loss for the further acoustic or EM signal(s) from the data acquisition acoustic or EM source to the data acquisition acoustic or EM detector under examination (db)
BL=the bottom loss for the reflective interface (db)
N_{HE}=data acquisition acoustic or EM detector sensitivity (db)
N_{AS}=gain of the amplifier connected to the data acquisition acoustic or EM detector under examination (db)
